(19) United States
(12) Patent Application Publication
(10) Pub. No.: US 2015/0216117 A1
(43) Pub. Date: Aug. 6, 2015

(54) METHOD FOR PRODUCING MARKING STRIPS USING AT LEAST TWO SEEDERS MOVING SIMULTANEOUSLY IN A FIELD

(71) Applicant: KUHN S.A., Saverne (FR)

(72) Inventors: Philippe Potier, Zittersheim (FR); Sylvain Citerne, Saverne (FR)

(73) Assignee: KUHN S.A., Saverne (FR)

(21) Appl. No.: 14/428,764

(22) PCT Filed: Sep. 16, 2013
(86) PCT No.: PCT/FR2013/052112

§ 371 Date: Mar. 17, 2015

(30) Foreign Application Priority Data
Sep. 19, 2012 (FR) 12 58788

(51) Int. Cl. A01C 21/00

(52) U.S. Cl. CPC A01C 21/005

(57) ABSTRACT

A method for producing marking strips using at least two seeders moving simultaneously in a field in which one seeder is a head seeder and at least one other seeder follows the head seeder being laterally offset, each seeder includes a control unit and plural rows that can respectively be activated for sowing or deactivated to produce tracks without seeds which will be used as a circulation lane for a treating apparatus in post-treatment operations. Each control unit includes a software program defining, with regard to fixed working parameters, an automatic operating program for activating or deactivating at least one of the rows of one of the seeders.

The present invention relates to the general technical field of agricultural machinery. The invention concerns a method for producing marking strips using at least two seeders moving simultaneously in a field.

It is known that in order to satisfy the needs of a plant during its growth and ensure good crop yields from the field, cultivation operations involving fertilization and phytosanitary treatments are necessary. These various operations are carried out according to the stage of maturity of the plants. In order to ensure that all the plants are treated, the field is tramlined, that is to say, it is provided with unseeded parallel tracks serving as reference markings for the treating apparatuses. The tramlining takes place during the seeding by means of the closing of the appropriate distribution elements corresponding to the track of the tractor used for the post-treatment operations after a specified number of to and fro trips of the seeder across the field. In practice, the seeders include a device making it possible to carry out such tracks in the seeded field. These tracks will be used during fertiliser spreading and/or during phytosanitary treatments. The fact of cutting off the distribution element in order to put the tracks for the treating apparatus in evidence prevents the crushing of the plants while the treating apparatus is passing over and more importantly prevents the wasting of seeds. The frequency of occurrence of tramlining in a field is based on the width of the seeder and that of the treating apparatus in such a manner as to avoid overlaps and/or gaps between two passes.

In order to carry out these treatment operations, and especially for the harvest, it is necessary for the plants in the field to be at the same stage of growth, it is therefore important to ensure that the sowing of seeds takes place under substantially the same conditions; which is to say that the field should be seeded as rapidly as possible. Thus, for fields covering large surface areas, it is common practice that several seeders move in succession and work simultaneously. Given that the sowing takes place with several seeders that follow one another the tramlining cannot be carried out in an automatic manner. It is common practice to arrange for the control unit of the head seeder to provide the tramlining instructions. Thus, the operator of the head seeder is required to indicate with gestures upon reaching the end of the field, to one of the other operators, that the tramlining is now to be carried out by his seeder. He must also indicate him the distribution elements that are to be isolated in order to ensure that the corresponding furrows are free of seeds. As the seeders are run so as to follow one another and given that the tramlining is repeated on a periodic basis, the cultivation site operations are stopped regularly with a more or less long waiting period.

The goal of the present invention consists in overcoming the drawbacks of the state of the art by providing for an automatic tramlining in the case of a site with multiple seeders.

To this end, the invention provides for a method for producing marking strips using at least two seeders moving simultaneously in a field in which one seeder is the head seeder and at least one other seeder follows the head seeder, being laterally offset, each seeder has a control unit and several rows that can respectively be activated for sowing or deactivated to produce tracks without seeds which will be used as a circulation lane for a treating apparatus in post-treatment operations, each control unit comprising a software programme defining, with regard to fixed working parameters, an automatic operating programme for activating or deactivating at least one of the rows of one of the seeders.

Thanks to the invention, each seeder is autonomous with respect to determining the tramlining rhythm, as a consequence whereof, all the seeder operators are able to stay focused on properly manoeuvering the half turns at the end of the field. With the method for producing marking strips as per the present invention, the tramlining is no longer dependent on the operator of the head seeder since each seeder is automatically configured in order that the tracks are put in evidence in the right place and by the appropriate seeder. The concentration and correctness of the signs made by the operator of the head seeder are no longer crucial to obtain tracks without seeds. The risk of error due to a misunderstanding, such as the period of waiting time required for transmission of tramlining instructions are eliminated.

Other features and advantages of the invention will become apparent from the description that follows considered with respect to the attached drawings which are only provided by way of non-limiting examples of the invention. In these drawings:

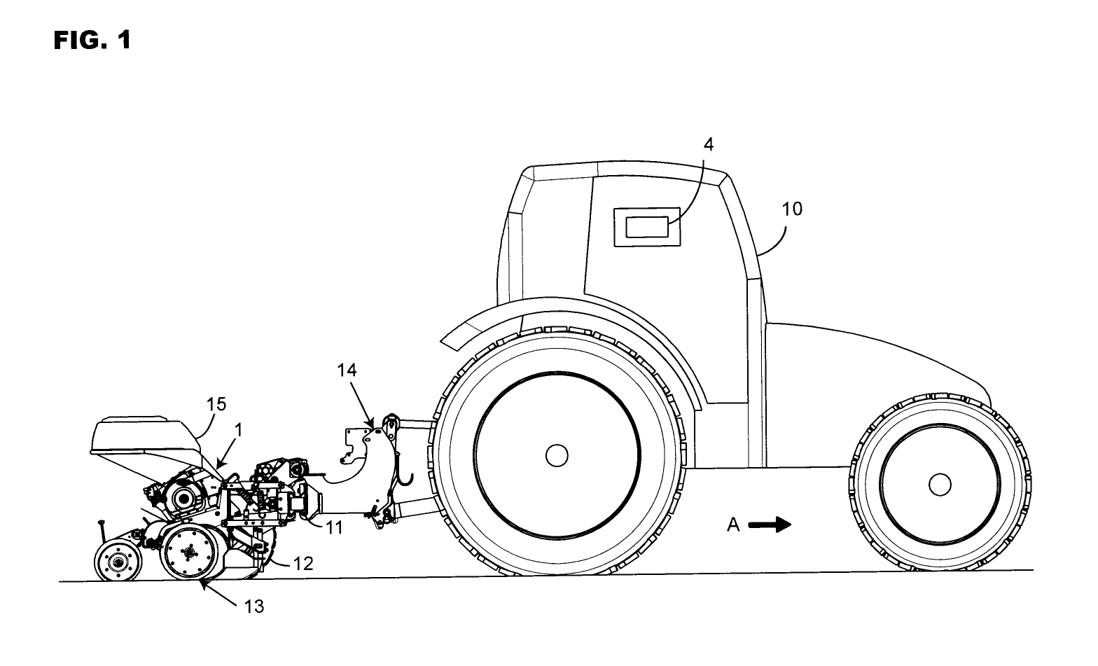

FIG. 1 is a side view of one of the seeders equipped in accordance with the present invention and hitched to a tractor,

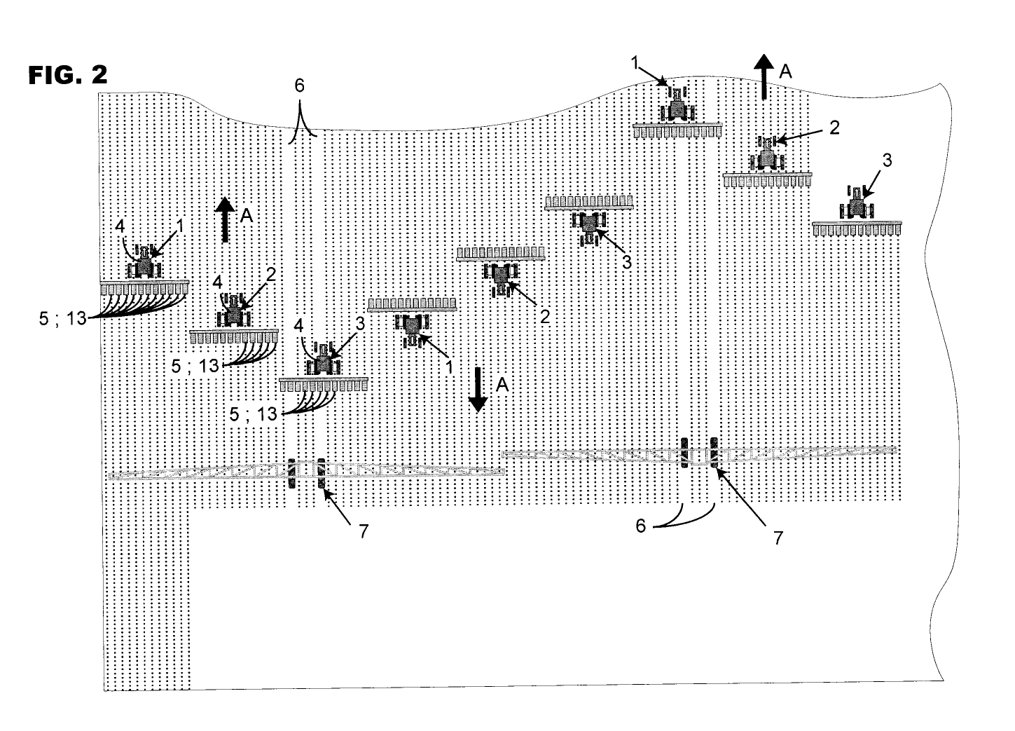

FIG. 2 shows, in a simplified and schematic form, a top view of a field on which travel several seeders according to the present invention.

FIG. 1 shows a seeder (1) hitched to a tractor (10) in a work configuration which is capable of distributing the seeds in several rows (5).The seeder (1) comprises a chassis (11) that rests on the ground by means of carrier wheels (12) and seeder elements (13) that are regularly distributed in a uniform and adjustable manner over the said chassis (11). The chassis (11) includes a coupling frame (14) making it possible to establish a connection to a three point hitch of the tractor (10). The tractor (10) moves the seeder (1) along a direction of advance indicated by the arrow (A). In the following description, the notions “before”, “rear” and “front”, “back” are defined in relation to the direction of advance (A). To control and monitor the seeding operation, the seeder (1) has a control unit (4). This control unit (4) also makes it possible to control the tramlining, that is to say, to have unseeded tracks at predetermined intervals. These tracks will be used during fertiliser spreading and/or during phytosanitary treatments carried out by means of treating apparatuses (7). As a general rule, the treating apparatuses (7) have a treatment width that is greater than the working width of the seeder (1). The treating apparatuses are, for example, a fertiliser spreader, a sprayer, etc. These intervals for creating travel lanes are determined with regard to the working width of the seeder (1) and the treatment width of the treating apparatuses (7).

The seeder (1) shown in FIG. 1 is a single seeder that distributes the seeds one by one over the seeding row based on constant spacings. Such a seeder (1) works over several rows (5) and has one seeder element (13) per seeding row. The chassis (11) is constituted of a transverse beam that is substantially horizontal and directed perpendicularly to the direction of advance (A) during work, over which are distributed the seeder elements (13) according to a defined and adjustable spacing arrangement. The transverse beam may have a variable length. The seeder elements (13) are advantageously distributed symmetrically over the transverse beam relative to the median vertical plane of the seeder (1). Each seeder element (13) has its hopper (15), its distribution element, its burying, tamping, covering and depth control elements. Each seeder element (13) is respectively mounted on the chassis (11) by means of a deformable parallelogram, which enables the seeder element (13) to remain parallel to the ground in all positions. The role of the distribution element is to extract the seeds one by one from the hopper and to distribute them at constant intervals along the seeding row. The hopper (15) constitutes the reserve for seeds and normally supplies seeds for a row.

FIG. 2 schematically represents a field to be sowed with seeds, shown in a top view, over which a plurality of seeders are made to travel simultaneously. For the remainder of the description, the notions “right” and “left” are defined when looking at the seeder from the rear in the direction of advance (A). It is to be noted that seeding begins along the left edge of the plot of land with the head seeder (1). In the example of an embodiment represented in FIG. 2, the seeding is carried out by means of three seeders (1, 2, 3) which travel along the same direction of advance. The head seeder (1) begins the seeding from the edge of the field and the other seeders (2, 3) follow the head seeder (1) in a laterally offset manner. The lateral offset corresponds to the working width of the preceding seeder.

The present invention provides a method for producing marking strips using at least two seeders (1, 2, 3) moving simultaneously in a field in which one seeder is the head seeder (1) and at least one other seeder (2, 3) follows the head seeder (1), being laterally offset, each seeder (1, 2, 3) has a control unit (4) and several rows (5) that can be respectively activated for the seeding or deactivated to produce tracks (6) without seeds which will be used as a circulation lane for a treating apparatus (7) in post-treatment operations, each control unit (4) comprising a software programme defining, with regard to fixed working parameters, an automatic operating programme for activating or deactivating at least one of the rows (5) of one of the seeders (1; 2; 3). With this tramlining method, in the presence of several seeders (1; 2; 3), circulation lanes without seeds for the treating apparatus (7) are determined in an automatic manner by means of the software programme contained within the control units (4). The automatic operating programme thus makes it possible to give the tramlining information to the appropriate seeder(s). The production of these tracks in the field is therefore no longer dependent on the operators. The head seeder operator no longer needs to concentrate on performing the gestures enabling the other operators to create the tracks in the right places. By using this automatic tramlining determination method, the risk of errors, with respect to the placement of the circulation lanes, is eliminated. The work of the seeder operators is thus simplified so that they may stay focused on the one hand, on properly manoeuvering the half turns at the end of the field, and on the other hand, on the driving of the tractor in a manner so as to ensure that a rectilinear seeding is achieved. In addition, with these circulation lanes, where there are no seeds to grow, there is no likelihood of the wheels of the tractor crushing the plants growing from the seeds.

FIG. 2 is a simplified representation of the seeding of a part of a field with three seeders (1, 2, 3). Each point is a material representation of a seed planted in the soil and the boundaries of the field are materially represented by a fine line. For a better understanding, the seeders (1, 2, 3) are represented on the field that is already seeded. In this figure, each seeder (1, 2, 3) is represented three times so as to show the successive passes made by each of them. One of the seeders (1, 2, 3) is the head seeder (1) and two other seeders (2, 3) follow the head seeder (1) while being laterally offset towards the part of the field that is still to be sown with seeds.

In practice, the strip situated at the edge of the field is seeded by the head seeder (1) which starts on the site. The seeding of the strip directly adjacent, in the part of the field that is still to be seeded, is performed by the second seeder (2) which follows the head seeder (1). Thereafter the next strip is seeded by the third seeder (3), of which some seeding rows have been deactivated for the tramlining in the example shown. The third seeder (3) follows the second seeder (2). The strip that follows will be sown by the head seeder (1) after having made a half turn, and then will follow the second seeder (2) and the third seeder (3), etc. It is to be noted that two strips of the field that are directly adjacent are always seeded by two different seeders. The offset in the direction of advance (A) of the head seeder (1) and the second seeder (2) and the third seeder (3) is of the order of several tens of metres. The seeders (1, 2, 3) work one behind the other, while being offset laterally. The width of the strips corresponds to the working width of each seeder (1, 2, 3). The lateral offset corresponds to a working width of the seeder. Thus the lateral offset of the second seeder (2) relative to the head seeder (1) corresponds to the working width of the head seeder (1). The lateral offset of the third seeder (3) relative to the head seeder (1) corresponds to the working width of the head seeder (1) added to the working width of the second seeder (2).

Each seeder (1, 2, 3) has the same working width, that is to say the same number of rows with the same spacing distance between rows. The treatment width of the treating apparatus (7) represents at least four times the working width of a seeder. The treating apparatus (7) is represented by a spraying boom. It is possible to distinguish normal passes and passes with tramlined track, that is to say, with at least one non seeded row. The normal passes correspond to passes for which all of the rows (5) of the seeder are deactivated. In the example represented, the passes with tramlined track are the first pass of the third seeder (3) and the third pass of the head seeder (1). For these two passes with tramlined track, it is to be noted that two rows (5) have been deactivated in order to create seeding rows or tracks without seeds. Between the first pass and the second pass, each seeder (1, 2, 3) has executed a half turn at the end of the field. The example shown corresponds to a tramlining rhythm for seeders having twelve rows with a spacing distance of 45 cm between rows and a sprayer of 24 m with a track of 1.80 m and one row per track. The seeders (1, 2, 3) represented, are of the single seeder type.

It is to be noted that the seeding of the field begins on the left side of the field and that only the first pass of the head seeder (1) begins at the bottom edge of the field, for all the other passes the seeding starts, and stops, respectively, at some distance from this edge. This zone is free of seeds so as to enable the tractor to execute the half turn manoeuvres without displacing the seeds. This zone will be seeded last when all of the central part has been seeded.

Preferably, one lane or track without seeds is produced by means of deactivating of one or several rows (5) of the seeder. In order to do this, the seeder (1, 2, 3) has at least one activating or deactivating device. In an advantageous manner, several rows (5) are equipped with such an activating or deactivating device. Some seeders even have such an activating or deactivating device for each row (5). In the example of the single seeder, it entails the causing or not of the distribution from one or more seeder elements with regard to the position of the tramlined tracks in the field and to the strip which will be seeded by one of the seeders (1, 2, 3).

As the lanes for circulation of the treating apparatus (7) are produced at the time of seeding, it is necessary to indicate some working parameters to the control unit (4) for the seeders (1, 2, 3). These parameters are the number of rows, the spacing between rows, the treatment width and width of the track for the treatment apparatus (7), the number of rows to be cut off per track (6), the number of seeders and the number of the seeder. It will also be necessary to input information on the side of the edge for the first pass. In order to simplify the number of entries to be made in the control unit (4), it is also possible to directly input the desired tramlining rhythm. The rhythm is calculated by using the number of rows multiplied by the spacing distance between rows, which gives the working width of the seeder. The ratio of the treatment width to the working width thus gives the rhythm. The rhythm is also a working parameter.

With this information, the software programme of each control unit is able to determine the automatic operating programme for deactivating at least one of the rows (5) of one of the seeders (1; 2; 3). In addition, the automatic operating programme determines for each seeding row (5) whether it is to be activated or deactivated in order to produce the tracks (6) as close as possible to the theoretical position of the tracks of the treating apparatus (7). The automatic operating programme calculates the position of the rows (5) with regard to the side of the edge of the first pass. As the method for producing marking strips is put into operation by means of several seeders, the working parameters are inserted into the control unit (4) of each seeder (1, 2, 3). The working parameters may be entered into each control unit (4) individually. In order to avoid errors and reduce the waiting time before the start of work on the site, the working parameters for the most part, may be entered into one of the control units and subsequently may be transferred to the other control units by means of a wireless link or via a removable storage medium. On the other hand, it will be necessary to systematically enter for each control unit (4) the number or the position of the seeder that has been assigned to it in relation to the other seeders (1, 2, 3). In an alternative embodiment, these working parameters are transferred from an electronic machine such as a computer for management of the farm.

In this method for producing marking stripes, it is important to ensure compliance with the order of placement of the seeders (1, 2 3) in the field. Thus, there is a head seeder (1) that initiates the work on the site while respecting the appropriate side of the edge for the first pass and the other seeders (2, 3) follow the head seeder (1) in the same direction and in accordance with the respective assignment number. The head seeder (1) is the first seeder, the one that starts work in the field. In order for the tracks (6) without seeds to be well positioned, each control unit (4) must monitor the changes in direction of travel of the respective seeder (1, 2, 3). The change in direction takes place during the half turn of the tractor at the end of the field. Each seeder is equipped with a detection means for detecting the half turn. According to one example of embodiment, the detection means is an end stop sensor placed on a seeder element for detecting when this seeder element is at its upper limit stop. In an alternative embodiment, the detection means is placed on the pre-emergence marker. The detection means may also be a speed sensor. According to another possibility the determination of the change in direction of the seeder (1, 2, 3) is to follow the position of the hydraulic lift of the tractor. In effect, when the seeder reaches the end of the field, the operator lifts the seeder so as to carry out the half turn.

According to the example of embodiment represented, the seeders (1, 2, 3) comprise a same number of rows and a same spacing distance between rows. In an alternative embodiment not shown, the seeders (1, 2, 3) comprise a different number of rows and/or a different spacing distance between rows. The seeders (1, 2, 3) are of the seed drill type or single seeder type.

The invention also happens to be applicable for a seed drill. The device for activating and deactivating is carried out in the form of a closing system that enables or not the supply of seeds to the row or rows (5).

In another embodiment of the invention, the automatic operating programme is capable of managing the tracks (6) for two treating apparatuses (7), whereof the working width and/or the width of the tracks are different. The information relating to the working parameters of the two treating apparatuses (7) are entered into the control units (4).

It is quite obvious that the invention is not limited to the embodiments described herein above and represented in the attached drawings. Modifications remain possible, in particular with regard to the constitution or the number of the various elements or by way of substitution of technical equivalents, without in any way departing from the scope of protection as defined by the following claims.

1-12. (canceled)

13. A method for producing marking strips using at least two seeders moving simultaneously in a field wherein one seeder is a head seeder and at least one other seeder follows the head seeder, being laterally offset, each seeder includes a control unit and plural rows that can be respectively activated for a seeding or deactivated to produce tracks without seeds which will be used as a circulation lane for a treating apparatus in post-treatment operations, each control unit including a software program defining, on the basis of fixed working parameters, an automatic operating program for activating or deactivating at least one of the rows of one of the seeders.

14. A method according to claim 13, wherein the working parameters are a number of rows, a spacing between rows, a treatment width and width of the track for the treatment apparatus, a number of rows to be cut off per track, a number of seeders, and a number of the seeder.

15. A method according to claim 13, wherein one of the seeders is the head seeder that initiates work on the site while respecting an appropriate side of the edge for a first pass and other seeders follow the head seeder in a same direction and in accordance with the respective assignment number.

16. A method according to claim 13, wherein the automatic operating program determines for each seeding row whether it is to be activated or deactivated in order to produce the tracks as close as possible to a theoretical position of the tracks of the treating apparatus.

17. A method according to claim 13, wherein the seeders comprise a same number of rows and a same spacing distance between rows.

18. A method according to claim 13, wherein seeders comprise a different number of rows and/or a different spacing distance between rows.

19. A method according to claim 13, wherein a number of the seeder is input systematically into each control unit.

20. A method according to claim 13, wherein the automatic operating program calculates a position of the rows with regard to a side of an edge of a first pass.

21. A method according to claim 13, wherein each control unit monitors a change in direction of the respective seeder after a half turn at an edge of a field.

22. A method according to claim 13, wherein each control unit has a same software program.

23. A method according to claim 13, wherein the seeders are of a seed drill type or single seeder type.

24. A method according to claim 13, wherein the automatic operating program is capable of managing tracks for two treating apparatuses, whereof a working width and/or a width of the tracks are different.
